(19) United States
(12) Patent Application Publication
(10) Pub. No.: US 2026/0049481 A1
(43) Pub. Date: Feb. 19, 2026

(54) Removable plank walkway

(71) Applicant: Shu Lin, Yueqing City (CN)

(72) Inventor: Shu Lin, Yueqing (CN)

(73) Assignee: Shu Lin, Yueqing City (CN)

(21) Appl. No.: 18/891,917

(22) Filed: Sep. 20, 2024

(30) Foreign Application Priority Data
Aug. 14, 2024 (CN) 2024219594458

(51) Int. Cl. E04F 15/02; E04F 15/04; F16B 7/14

(52) U.S. Cl. CPC E04F 15/02044; E04F 15/04; F16B 7/14

(57) ABSTRACT

The present application provides a locking assembly and a wooden slat device, the locking assembly comprising a locking body and a telescopic rod; the locking body is provided with a first through-hole, and the telescopic rod is telescopically attached to the locking body; the telescopic rod is provided with a second through-hole, the second through-hole penetrating the telescopic rod and selectively connected or spaced apart from the first through-hole; the second through-hole is provided with an opening, and the opening opens or closes with the telescopic rod's telescope so that the second through-hole is connected or spaced apart from the second through-hole is provided with an opening that opens or closes as the telescoping rod is telescoped, so that the second through-hole is connected or spaced apart from the first through-hole.

### TECHNICAL FIELD

The present invention patent relates to the technical field of wood slat devices, and in particular to a locking assembly and a wood slat device.

### BACKGROUND

With the development of science and technology, wooden slat devices are widely used in many places, such as public buildings, commercial centers, medical institutions, schools, etc. The main function of wooden slat devices is to provide walking and moving channels for people, and the locking assembly as a part of the wooden slat device.

In the prior art, the existing locking assembly includes a locking body and a locking rod, the locking body is provided with a through-hole, the through-hole is used for the connecting rope to be threaded, and the locking rod connects to the locking body and locks the connecting rope, so the connecting rope does not have a free state, but only a locking state, which results in the existing locking assembly being insufficiently convenient for the connecting rope to be adjusted.

### SUMMARY

The object of the present invention patent is to provide a locking assembly and a wooden slat device, wherein the locking body is provided with a first through-hole, the first through-hole being used for a connecting rope to be threaded through; a telescopic rod is telescopically attached to the locking body; the telescopic rod is provided with a second through-hole, the second through-hole penetrating through the telescopic rod and selectively connected or spaced from the first through-hole; the second through-hole is provided with an opening, the opening or closing with the telescopic rod's telescopic expansion and contraction, so that the second through-hole is connected or spaced apart from the first through-hole; when the second through-hole is connected to the first through-hole, the connecting rope is threaded through the second through-hole and the first through-hole; when the second through-hole is spaced apart from the first through-hole, the connecting rope is locked in the openings and is in a static state, so as to regulate the locking or free state of the connecting rope by the telescoping of the telescoping rod with respect to the locking main body, thereby realizing control of the connecting rope to control the connecting rope for threading of the connecting rope to the wooden slats, improving the convenience of adjusting the connecting rope by the locking assembly.

In order to realize the above purpose, the present invention patent provides the following technical solutions:

A locking assembly comprising:

A locking body, provided with a first through-hole, said first through-hole being for threading of a connecting cord.

A telescoping rod, telescopically coupled to said locking body; said telescoping rod provided with a second through-hole, said second through-hole running through said telescoping rod and selectively connected or spaced from said first through-hole;

Said second through-hole is provided with an opening, said opening being opened or closed with the telescoping of said telescopic rod, such that said second through-hole is connected to or spaced from said first through-hole;

With said second through-hole in communication with said first through-hole, said connecting cord is threaded through said second through-hole and said first through-hole.

With said second through-hole spaced from said first through-hole, said connecting cord locks into said opening and is at rest.

Optionally, said locking body is provided with a telescoping slot.

Said telescoping rod is threaded through said locking body and telescopes within said telescoping groove.

Optionally, said telescoping groove has an elastic member built into it, said elastic member being between the inner side wall of said telescoping groove and the end of said telescoping rod and exerting an elastic force on said telescoping rod.

Optionally, the end of said telescopic rod is arranged in a conical shape, and a plurality of snap-in holes are provided in the circumferential sidewall of said telescopic rod, the plurality of said snap-in holes being connected to said second through-hole in different directions.

Optionally, said resilient member is a spring, said spring being provided with a hollow hole, said hollow hole connecting said opening, said first through hole.

Optionally, said locking assembly further comprises a plurality of snap-fit members, the plurality of said snap-fit members being in said telescoping groove and arranged relative to said snap-fit holes.

Optionally, a plurality of said snap-fit members approach said snap-fit holes as said telescoping rod is extended, the plurality of said snap-fit members contacting each other and sealing said openings to lock said connecting cord.

Optionally, said locking body is connected to a hook, said hook being used to hang the piece to be hung.

Optionally, said first through-hole is arranged at an angle.

A wooden slat device, said locking assembly, a plurality of wooden slats and a connecting cord.

Said connecting cord is threaded through a plurality of said plank strips and said locking assembly is mounted to one said plank strip and opens or locks said connecting cord.

The beneficial effects of the patented invention compared to the prior art are:

The present invention patent provides a locking assembly and a wooden slat device, the locking body is provided with a first through-hole, the first through-hole being used for a connecting rope to be threaded through; a telescopic rod is telescopically attached to the locking body; the telescopic rod is provided with a second through-hole, the second through-hole penetrating the telescopic rod and selectively connecting or spacing out from the first through-hole; the second through-hole is provided with an opening, and the opening opens or closes with the telescopic rod's expansion and contraction, so that the second through-hole is connected or spaced out from the second through-hole is provided with an opening, which opens or closes with the telescoping rod, so that the second through-hole is connected to or spaced apart from the first through-hole; when the second through-hole is connected to the first through-hole, the connecting rope is threaded through the second through-hole and the first through-hole; when the second through-hole is spaced apart from the first through-hole, the connecting rope locks in the opening and is in a static state, so as to adjust the locking state or free state of the connecting rope with the telescoping rod's retracting with respect to the locking main body, so as to realize the control of the connecting rope to control the connecting rope to be threaded to the wood slats the threading of the wooden slats, improving the convenience of adjusting the connecting rope by the locking assembly.

### DETAILED DESCRIPTION OF THE EMBODIMENTS

In order to more clearly illustrate the technical solutions in the embodiments of the present application, the accompanying drawings to be used in the description of the embodiments will be briefly described below. Obviously, the accompanying drawings in the following description are only some of the embodiments of the present application, and other accompanying drawings may be obtained from these drawings without creative labor for those skilled in the art.

For a more complete understanding of the present application and its beneficial effects, it will be described below in conjunction with the accompanying drawings. Among other things, the same accompanying drawing symbols in the following description indicate the same parts.

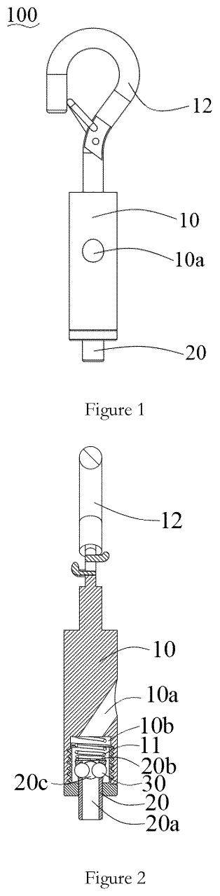

FIG. 1 illustrates a schematic view of a locking assembly according to an embodiment of the present application.

FIG. 2 illustrates a cross-sectional view of a locking assembly according to an embodiment of the present application.

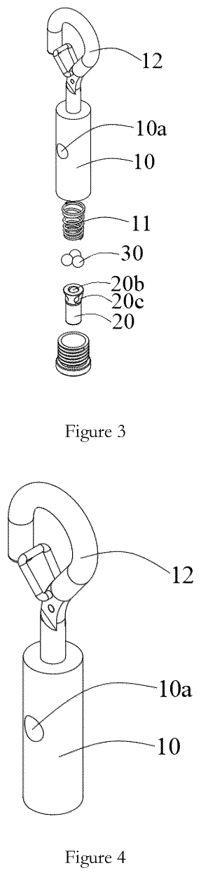

FIG. 3 illustrates an exploded view of a locking assembly according to an embodiment of the present application

FIG. 4 illustrates a schematic view of a locking body of a locking assembly according to an embodiment of the present application.

FIG. 5 illustrates a schematic view of a telescoping rod of a locking assembly according to an embodiment of the present application.

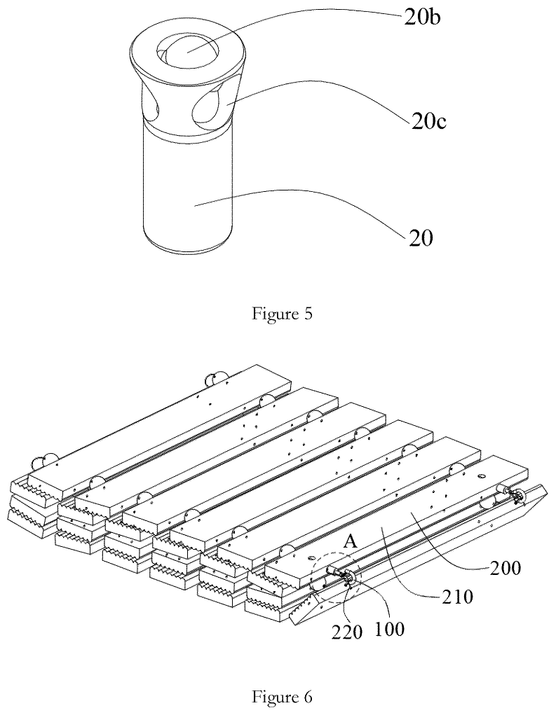

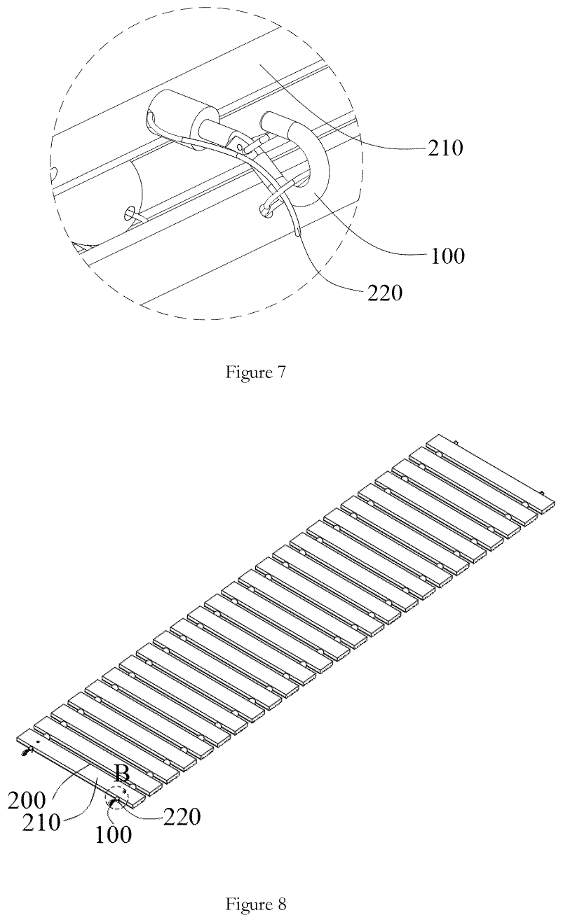

FIG. 6 illustrates a schematic view of a wooden slat device according to another embodiment of the present application.

FIG. 7 illustrates a partially enlarged view at A in FIG. 6.

FIG. 8 illustrates a schematic diagram of another state of a wooden slat device according to another embodiment of the present application.

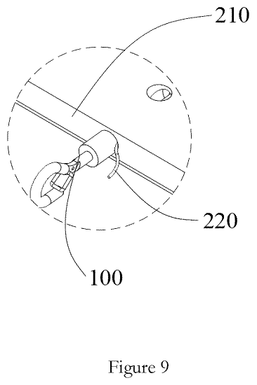

FIG. 9 illustrates a partially enlarged view at B in FIG. 8.

marker

100, Locking assembly;

10, locking body; 10a, first through-hole; 10b, telescopic groove; 11, elastic member; 12, hook;

20, telescoping rod; 20a, second through hole; 20b, opening; 20c, snap fit hole;

30. Snap fit parts;

200, wood slat device; 210, wood slats; 220, connecting rope.

The technical solutions in the embodiments of the present application will be clearly and completely described below in conjunction with the accompanying drawings in the embodiments of the present application. Obviously, the described embodiments are only a part of the embodiments of the present application, and not all of the embodiments. Based on the embodiments in the present application, all other embodiments obtained by a person skilled in the art without making creative labor fall within the scope of protection of the present application.

Referring to the accompanying FIGS. 1 to 9, embodiments of the present application provide a locking assembly 100, the locking assembly 100 being applied to a wooden slat device 200, wherein the locking assembly 100 is used as part of the wooden slat device 200.

In an embodiment of the present application, the locking assembly 100 comprises a locking body 10 and a telescopic rod 20, and the telescopic rod 20 is provided on an inner side of the locking body 10. At this time, the telescopic rod 20 is telescopically connected to the locking body 10 to regulate the locking state or the free state of the connecting rope.

Referring to FIGS. 1 to 5 of the accompanying drawings, in an embodiment of the present application, the locking body 10 serves as a support component of the locking assembly 100, the locking body 10 is used to support the telescopic rod 20, the locking body 10 is provided with a first through-hole 10a, the first through-hole 10a serves as an internal space of the locking body 10, and the first through-hole 10a is used for the connecting rope to be threaded; so as to allow the connecting rope to be realized to be threaded to the locking body 10 through the first through-hole 10a. 10 to be threaded.

At this time, the first through-hole 10a is arranged at an inclined angle, and the first through-hole 10a extends from the bottom of the locking body 10 to the circumference of the locking body 10, so as to facilitate threading of the connecting rope to the circumference of the locking body 10 via the bottom of the locking body 10, so as to facilitate pulling of the connecting rope by the user.

Referring to FIGS. 1 to 5 of the accompanying drawings, in this embodiment of the present application, the telescopic rod 20 is provided on the inner side of the locking body 10, and the telescopic rod 20 is telescopically attached to the locking body 10 and telescoped along the length direction of the locking body 10 so as to facilitate adjustment of the position of the telescopic rod 20 relative to the locking body 10; the telescopic rod 20 is provided with a second through-hole 20a, and the second through-hole 20a penetrates through the telescopic rod 20 and selectively connects or spacer with the first through-hole 10a selectively connected to or spaced apart from the first through-hole 10a; the second through-hole 20a is provided with an opening 20b, the opening 20b opening or closing as the telescoping rod 20 telescopes, such that the second through-hole 20a is connected to or spaced apart from the first through-hole 10a.

At this time, when the second through-hole 20a is connected to the first through-hole 10a, the connecting rope is threaded through the second through-hole 20a and the first through-hole 10a; when the second through-hole 20a is spaced apart from the first through-hole 10a, the connecting rope is locked in the opening 20b and is in a stationary state, so as to facilitate the adjustment of a locked state or a free state of the connecting rope by the expansion and contraction of the expansion and contraction of the expansion and contraction rod 20 with respect to the locking main body 10, so as to achieve the connecting rope control of the connecting rope so as to facilitate control of the threading of the connecting rope on the wooden slats, improving the convenience of adjustment of the connecting rope by the locking assembly 100.

Referring to FIGS. 1 to 5 of the accompanying drawings, wherein the locking body 10 is provided with a telescoping groove 10b; the telescoping groove 10b extends along the length direction of the locking body 10, and the telescoping rod 20 is threaded through the locking body 10, and the outer wall of the telescoping rod 20 is gap-fit between the outer wall of the telescoping rod 20 and the inner side wall of the telescoping groove 10b, and telescopes inside the telescoping groove 10b, so as to facilitate telescoping of the telescoping rod 20 with the telescoping groove 10b to achieve telescoping relative to the locking body 10, thereby facilitating adjustment of the position of the telescopic rod 20 relative to the locking body 10, the opening 20b opening or closing with the telescopic rod 20's telescoping, so that the second through-hole 20a and the first through-hole 10a are connected or spaced apart, and in the case where the second through-hole 20a is connected with the first through-hole 10a, the connecting rope is threaded between the second through-hole 20a and the first through-hole 10a; and in the case where the second through-hole 20a is spaced apart from the first through-hole 10a, the connecting rope is locked by the locking body 10a. 10a are spaced apart, the connecting rope locks in the opening 20b and is in a stationary state, so as to facilitate regulation of the locking state or the free state of the connecting rope by the expansion and contraction of the telescopic rod 20 relative to the locking body 10, thereby realizing the control of the connecting rope so as to facilitate control of the threading of the connecting rope to the wooden slats, and improving the convenience of adjustment of the locking assembly 100 with respect to the connecting rope.

Referring to FIGS. 1 to 5 of the accompanying drawings, in this embodiment of the present application, the telescopic groove 10b is built-in with an elastic member 11, the elastic member 11 is between the inner side wall of the telescopic groove 10b and the end portion of the telescopic rod 20, and exerts an elastic force on the telescopic rod 20 so as to allow the telescopic rod 20 to extend with respect to the locking main body 10 under the elastic force of the elastic member 11, thereby facilitating that the telescopic rod 20, in the absence of an external force, is always in a locking state with respect to the connecting rope in a locking state, preventing the connecting rope from automatically detaching from the telescopic rod 20.

In an embodiment of the present application, the end of the telescopic rod 20 is arranged in a tapered shape, the circumferential sidewall of the telescopic rod 20 is provided with a plurality of snap holes 20c, the plurality of snap holes 20c are connected to the second through-hole 20a in different directions, and the locking assembly 100 further comprises a plurality of snap members 30, the plurality of snap members 30 are located in the telescopic groove 10b and are arranged with respect to the snap holes 20c, the plurality of snap members 30 are connected to the second through-hole 20a along with the, extends and approaches the snap fit hole 20c, the plurality of snap fit members 30 contacting each other and sealing the opening 20b to lock the connecting rope so as to facilitate the plurality of snap fit members 30 squeezing an outer peripheral side of the connecting rope, thereby facilitating the connecting rope to be in a locked state with respect to the telescopic rod 20, and optionally, the snap fit members 30 being round beads.

At this time, each of the snap-fit members 30 is movably snap-fit in each of the snap-fit holes 20c so as to facilitate adjustment of the position of each of the snap-fit members 30 relative to each of the snap-fit holes 20c, wherein the diameter of the end portion of the telescopic rod 20 is gradually enlarged from the bottom upward, and the plurality of snap-fit members 30 are at the bottom of the snap-fit holes 20c so as to facilitate reduction of the clearance between the plurality of snap-fit members 30 so as to facilitate squeezing of the connecting ropes by the plurality of snap-fit members 30, which in turn facilitates the In addition, when the telescopic rod 20 is compressed relative to the locking body 10 under an external force, the plurality of snap-fit members 30 move upward so as to increase the gap between the plurality of snap-fit members 30, thereby facilitating the plurality of snap-fit members 30 to disengage from the connecting rope, and thereby facilitating the connecting rope to be in a free state, so as to realize the locking state or the free state of the connecting rope through the expansion and contraction of the telescopic rod 20 relative to the locking body 10. or the free state, thereby realizing the control of the connecting rope so as to facilitate control of the threading of the connecting rope to the wooden slats and improving the convenience of adjustment of the locking assembly 100 to the connecting rope, thereby facilitating the disassembly between the wooden slats and the connecting rope.

Referring to FIGS. 1 to 5 of the accompanying drawings, in this embodiment of the present application, the elastic member 11 is a spring, the spring is provided with a hollow hole, and the hollow hole is connected to the opening 20b, and the first through-hole 10a, so as to facilitate threading of the connecting rope to the outer side of the locking main body 10 via the opening 20b, the hollow hole, and the first through-hole 10a in order to facilitate threading of the connecting rope in relation to the locking main body 10, thereby facilitating the wooden slats and the connecting rope to be disassembly.

In an embodiment of the present application, the locking body 10 is connected to a hook 12, the hook 12 being used to hang the to-be-suspended member so as to allow the locking body 10 to be bound to the to-be-suspended member by the hook 12.

Workflow: stretching workflow: the telescoping rod 20 extends relative to the locking body 10 under the elastic action of the elastic member 11, the plurality of snap-fit members 30 approach the snap-fit holes 20c as the telescoping rod 20 extends, the plurality of snap-fit members 30 contact each other and block the opening 20b, and when the connecting rope is threaded to the opening 20b through the second through-hole 20a, the end of the connecting rope tops off the plurality of snap-fit members 30, the plurality of snap-fit members 30 extend relative to the locking body 10 under the elastic action of the connecting retracting rod 20 under the elastic action of the elastic member 11, the plurality of snap-fit members 30 approach the snap-fit aperture 20c with the extension of the retracting rod 20, the plurality of snap-fit members 30 contact each other and block the opening 20b, when the connecting rope is threaded through the second through-hole 20a into the opening 20b, the end portion of the connecting rope tops off the plurality of snap-fit members 30, and the plurality of snap-fit members 30 are in the connecting, The plurality of snap-fit members 30 separate from each other under the force of the connecting rope, so as to facilitate the connecting rope to be threaded through the second through-hole 20a, the opening 20b, the hollow hole of the resilient member 11, and the first through-hole 10a in sequence, thereby facilitating the plurality of snap-fit members 30 to extrude the circumference of the connecting rope, and thus facilitating the telescopic rod 20 to realize locking the connecting rope when it extends with respect to the locking main body 10 to achieve the connecting rope being in the locking state.

In addition, the telescopic rod 20 is compressed relative to the locking body 10 under the action of an external force, and the plurality of clamping members 30 are separated from each other along with the compression of the telescopic rod 20, so as to increase the gap between the plurality of clamping members 30, thereby facilitating the plurality of clamping members 30 to disengage from the connecting ropes, and thereby facilitating the connecting ropes to be in a free state, so as to achieve the control of the locking state or the free state of the connecting ropes by the telescopic rod 20's expansion and contraction relative to the locking body 10 or the free state, thereby realizing the control of the connecting rope so as to facilitate control of the threading of the connecting rope to the wooden slats, and improving the convenience of adjustment of the locking assembly 100 to the connecting rope, thereby facilitating the disassembly between the wooden slats and the connecting rope.

In another embodiment, a wooden slat device 200 includes a locking assembly 100, a plurality of wooden slats 210, and a connecting rope 220; the connecting rope 220 is threaded with a plurality of wooden slats 210, the locking assembly 100 is mounted to a wooden slat 210 and opens or locks the connecting rope so as to facilitate the adaptation of different numbers of wooden slats 210 by adjusting the position of the locking assembly 100 relative to the connecting rope 220, the ease of assembly of the wooden slat device 200 is improved.

The beneficial effects of the patented invention compared to the prior art are:

The present invention patent provides a locking assembly 100 and a wooden slat device 200, the locking body 10 is provided with a first through-hole 10a, the first through-hole 10a being used for a connecting rope to be threaded through; a telescopic rod 20 is telescopically connected to the locking body 10; the telescopic rod 20 is provided with a second through-hole 20a, the second through-hole 20a penetrating the telescopic rod 20 and being selectively connected or spaced apart from the first through-hole 10a; the second through-hole 20a is provided with an opening 20b, which opens or closes with the telescoping rod 20, such that the second through-hole 20a is connected to or spaced apart from the first through-hole 10a; when the second through-hole 20a is connected to the first through-hole 10a, a connecting cord is threaded through the second through-hole 20a and the first through-hole 10a; when the second through-hole 20a is spaced apart from the first through-hole 10a, the connecting cord locks into the opening 20b, and is in a stationary state, so as to facilitate the regulation of the locking state or the free state of the connecting rope by the expansion and contraction of the telescopic rod 20 relative to the locking body 10, thereby realizing the control of the connecting rope so as to facilitate the control of the threading of the connecting rope to the wooden slats, and improving the convenience of the locking assembly 100 for the adjustment of the connecting rope.

In the above embodiments, the description of each embodiment has its own focus, and parts of an embodiment that are not described in detail can be found in the relevant descriptions of other embodiments.

In the description of the present application, the terms “first” and “second” are used for descriptive purposes only and are not to be understood as indicating or implying relative importance or implicitly specifying the number of technical features indicated. Thus, a feature defined with the terms “first” and “second” may expressly or implicitly include one or more features.

In this paper, the application of specific examples of the principle and implementation of the application for the elaboration of the above examples are only used to help understand the application of the method and its core ideas; at the same time, for the technical personnel in the field, based on the application of the idea, in the specific implementation and application of the scope of the application will have to change the place, in summary, the contents of this specification should not be interpreted as a limitation.

What is claimed is:

1. a locking assembly characterized in that it comprises:
A locking body, provided with a first through-hole, said first through-hole being for threading of a connecting cord;
A telescoping rod, telescopically coupled to said locking body; said telescoping rod provided with a second through-hole, said second through-hole running through said telescoping rod and selectively connected or spaced from said first through-hole;
Said second through-hole is provided with an opening, said opening being opened or closed with the telescoping of said telescopic rod, such that said second through-hole is connected to or spaced from said first through-hole;
With said second through-hole in communication with said first through-hole, said connecting cord is threaded through said second through-hole and said first through-hole;
With said second through-hole spaced from said first through-hole, said connecting cord locks into said opening and is at rest.

2. A locking assembly according to claim 1, characterized in that said locking body is provided with a telescoping groove;
Said telescoping rod is threaded through said locking body and telescopes within said telescoping groove.

3. A locking assembly according to claim 2, characterized in that said telescoping groove has an elastic member built into it, said elastic member being between the inner side wall of said telescoping groove and the end of said telescoping rod and exerting an elastic force on said telescoping rod.

4. A locking assembly according to claim 2, characterized in that the end of said telescopic rod is arranged in a conical shape, said telescopic rod is provided with a plurality of snap holes in the circumferential sidewall of said telescopic rod, and a plurality of said snap holes are connected to said second through-hole in different directions.

5. A locking assembly according to claim 3, characterized in that said resilient member is a spring, said spring being provided with a hollow bore, said hollow bore being connected to said opening, said first through hole.

6. A locking assembly according to claim 3, characterized in that said locking assembly further comprises a plurality of snap-fit members, the plurality of said snap-fit members being in said telescoping groove and arranged relative to said snap-fit holes.

7. A locking assembly according to claim 6, characterized in that a plurality of said snap members approach said snap holes as said telescoping rod is extended, the plurality of said snap members contacting each other and sealing said openings to lock said connecting cord.

8. A locking assembly according to claim 1, characterized in that said locking body is connected to a hook, said hook being used to hang the piece to be hung.

9. A locking assembly according to claim 1, characterized in that said first through-hole is arranged at an angle.

10. A wooden slat device characterized in that it comprises a locking assembly, a plurality of wooden slats and a connecting cord as claimed in any one of claims 1 to 9;
Said connecting cord is threaded through a plurality of said plank strips and said locking assembly is mounted to one said plank strip and opens or locks said connecting cord.
